(19) United States
(12) Patent Application Publication
(10) Pub. No.: US 2019/0317938 A1
(43) Pub. Date: Oct. 17, 2019

(54) METHOD, PROGRAM, AND SYSTEM FOR AUTOMATIC DISCOVERY OF RELATIONSHIP BETWEEN FIELDS IN ENVIRONMENT WHERE DIFFERENT TYPES OF DATA SOURCES COEXIST

(71) Applicant: SMART INSIGHT CORPORATION, Chiyoda-ku Tokyo (JP)

(72) Inventors: Rahul AGARWALLA, Chiyoda-ku Tokyo (JP); Kiyoshi MACHIDA, Chiyoda-ku Tokyo (JP); Toshiaki NAKAGAWA, Chiyoda-ku Tokyo (JP)

(21) Appl. No.: 16/089,532

(22) PCT Filed: Mar. 27, 2017
(86) PCT No.: PCT/JP2017/012496

§ 371 Date: Jun. 24, 2019

Related U.S. Application Data
(60) Provisional application No. 62/315,784, filed on Mar. 31, 2016.

(51) Int. Cl. G06F 16/2458; G06F 16/28; G06F 16/901; G06F 16/2455; G06F 17/11

(52) U.S. Cl. CPC G06F 16/2458; G06F 16/288; G06F 17/11; G06F 16/2456; G06F 16/9024

(57) ABSTRACT

[PROBLEM TO BE SOLVED] To efficiently associate fields for performing data analysis across a plurality of data sources having different designs, facilitating various analyses.

[SOLUTION] Set indices for each field in a plurality of data stores, determine similarity between each field, and generate an enterprise data graph, a graph format data with highly similar fields as nodes. To determine similarity, a technique such as a morphological analysis provided by a search engine may be used. By using the enterprise data graph, it is possible to handle various inquiry requests that run across multiple data stores.

### BACKGROUND

The present disclosure relates to systems and methods for analyzing databases of information, and more specifically to systems and methods of autonomously mapping relationships between entities in heterogeneous data sources.

### RELATED ART

Modern day companies or enterprises spread data across multiple, different data sources. For example, every department of a company (e.g. sales, services, shipping) may have its own data sources. There is a growing need to combine data from different data sources for reporting and analytics. Here, data source means technologies to store and provide data in general. Data sources are typically databases but are not limited to them. Examples of data sources will be explained later. A data source also is called “data repository”, “data store”, “data storage” and so on, depending on the context.

However, in the conventional system, it was difficult to determine where the data is located and how the fields in the plurality of data sources are related to each other. For example, even for a product of the same model, the product code could be different between the sales department database and the service department database. In different data sources, the field names of the related data could be different. Sometimes it was meaningless to associate fields between different data sources. In addition, each data source often had a different data model designed by another data designer. In addition, the data in the data source is not necessarily clean (for example, there may be data missing, incorrect data, format errors). Also, depending on the data source, the same input items may be stored in different formats. Considering that the amount of data in the enterprise becomes petabytes from terabytes, in the conventional system, in many cases, it was not easy to judge the relationship between tables (entities) and fields in different data sources.

To solve the above issues, a technology called EII (Enterprise Information Integration) was proposed (for example, prior patent document (JP2000-222430A) and prior nonpatent document (Wikipedia—Enterprise Information Integration)), but it is still difficult to correlate fields among multiple databases with different designs, and EII does not quite live up to its promise.

Prior Patent Document: JP2000-222430A

Prior Non Patent Document: (Wikipedia—Enterprise Information Integration)

### PROBLEM TO BE SOLVED

To provide efficient methods, programs and systems to corelate fields across heterogeneous data sources for data analysis.

### SUMMARY

The present invention solves the above problem by providing a computer-executable method to analyze data in multiple data stores comprising: removing duplicates from a set of strings in multiple fields in tables in the multiple data stores; storing the set of strings into an inverted index; evaluating similarity among the multiple fields based on similarity of the strings stored in the inverted index; and, generating a graph, each node of the graph representing a table containing similar fields, and an edge of the graph representing similarity between the tables.

The present invention solves the above problem by providing the method according to paragraph 0008, wherein, the evaluating similarity step further comprising: dividing a set of strings in the multiple fields by applying Morphological Analysis; calculating a Cosine similarity between the strings; and applying a logistics function to the Cosine similarity.

The present invention solves the above problem by providing the method according to paragraph 0008, wherein, the evaluating similarity step further comprising: storing a set of strings in the multiple fields into a temporary tables; applying a natural join to the temporary tables; and calculating a similarity between the temporary tables.

The present invention solves the above problem by providing the method according to paragraph 0008, paragraph 0009 or paragraph 0010, further comprising: evaluating similarity between the multiple fields in tables in the multiple data stores, based on attributes of the fields; wherein the attributes include cardinality, non-distinctive values, a range of a histogram, a number of null values, and a number of non-null values.

The present invention solves the above problem by providing a computer-executable method using the graph generated by the method according to paragraph 0008, paragraph 0009, paragraph 0010 or paragraph 0011 comprising: receiving a query to a first field in a first table in a first data store; identifying, using the graph, a second field that is similar to the first field; and displaying the second field, a second table containing the second field or a second data store containing the second table.

The present invention solves the above problem by providing a computer-executable method using the graph generated by the method according to paragraph 0008, paragraph 0009, paragraph 0010 or paragraph 0011 comprising: displaying information on a first data store; receiving a query to a first field in a first table in a first data store; identifying, using the graph, a second field that is similar to the first field; displaying information on a second data store containing the second field; and updating display of the information of the first data store and the information of the second data store simultaneously.

The present invention solves the above problem by providing computer-executable method using the graph generated by the method according to paragraph 0008, paragraph 0009, paragraph 0010 or paragraph 0011 comprising: receiving a query to a first field in a first table in a first data store; identifying, using the graph, a second field that is similar to the first field; and displaying the result of the query to the first data store and a second data store containing a second table containing the second field on a same screen.

The present invention solves the above problem by providing a computer-executable method using the graph generated by the method according to paragraph 0008, paragraph 0009, paragraph 0010 or paragraph 0011 comprising: receiving a keyword from a user; searching tables containing a field containing the keyword from the inverted index; and displaying the table or the field.

### EFFECTS OF INVENTION

Efficient methods, programs and systems to corelate fields across heterogeneous data sources for data analysis are provided.

### BRIEF DESCRIPTION OF THE DRAWINGS

FIG.1 illustrates an example embodiment of data storage in an enterprise.

FIG. 2 illustrates a process for generating enterprise data graph that may be performed by the data management and analysis device according to an example implementation of the present application.

FIG. 3 illustrates a first exemplary algorithm for evaluating similarity among fields in tables according to the present application.

FIG. 4 illustrates a second exemplary algorithm for evaluating similarity among fields in tables according to the present application.

FIG. 5 illustrates schematic representation of enterprise data graph according to an example implementation of the present application.

FIG. 6 illustrates an example screen display of enterprise data graph according to an example implementation of the present application.

FIG. 7 illustrates a process for performing the first embodiment of the queries using the enterprise data graph that may be performed by the data management and analysis device according to an example implementation of the present application.

FIG. 8 illustrates a process for performing the second embodiment of the queries using the enterprise data graph that may be performed by the data management and analysis device according to an example implementation of the present application.

FIG. 9 illustrates a process for performing the third embodiment of the queries using the enterprise data graph that may be performed by the data management and analysis device according to an example implementation of the present application.

FIG. 10 illustrates a process for performing the fourth embodiment of the queries using the enterprise data graph that may be performed by the data management and analysis device according to an example implementation of the present application.

FIG. 11 illustrates a functional block diagram of the data management and analysis device according to an example implementation of the present application.

FIG. 12 illustrates an exemplary computing environment including computing devices suitable for embodiments of the present invention.

### DETAILED DESCRIPTION

The subject matter described herein is taught by way of example implementations. Various details have been omitted for the sake of clarity and to avoid obscuring the subject matter. All the drawings are exemplary.

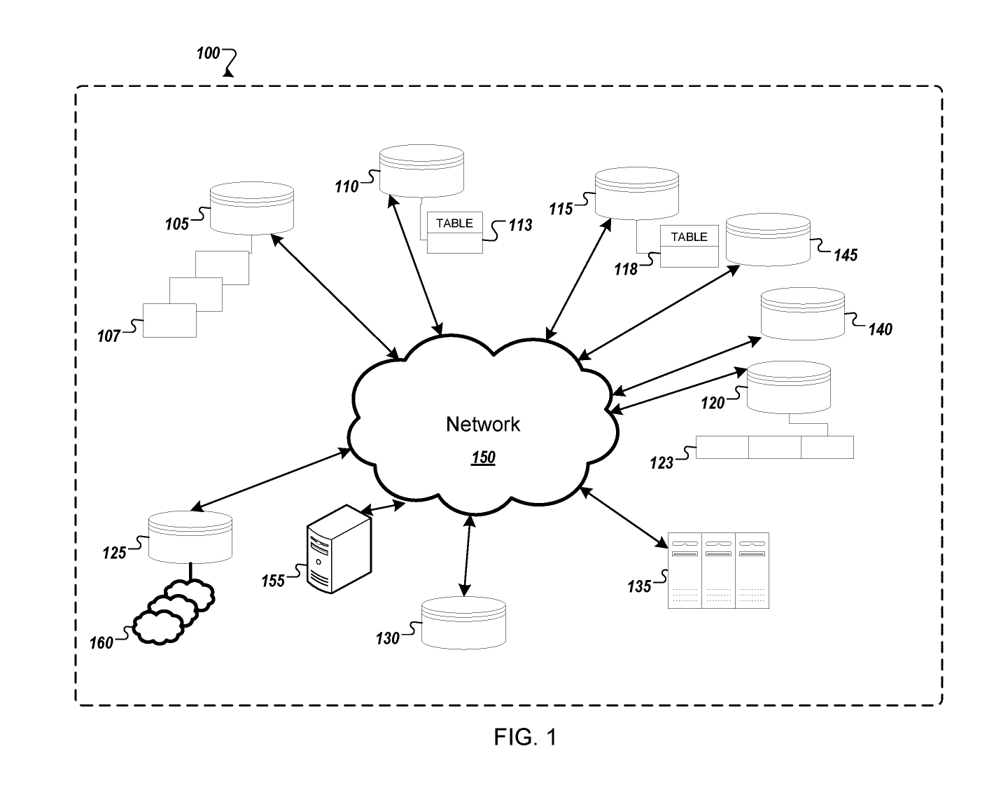

FIG. 1 illustrates an example embodiment of various data sources in an enterprise environment 100. Data stored in the enterprise environment 100 can be provided from a variety of data sources 105-135. One type of data source includes a search engine 105. The search engine 105 (e.g., SOLR or ELASTICSEARCH) may be useful in storing and searching textual data, because search engines use an inverted index storage for fast searches by tokenizers or n-grams. An inverted index stores terms or keywords mapped to a set of documents 107. Each document may correspond to a single record composed of one or more attribute values. Some fields of each record may be indexed to facilitate efficient searching.

Another type of data source includes a relational database 110 (also referred to as “Relational Database Management Systems” (RDBMS)) that stores data in tables 113, with each table representing an entity in the system and specific attributes representing relationships between these entities. Relationships may be one-to-one, one-to-many or many-to-many relationships. RDBMS may be queried using Structured Query Language (SQL) and offer a robust and mature mechanism to store and query structured data. RDBMS typically use B-Tree data structures for efficient retrieval from a disk and insertion into the relational database 110. A B-tree is a tree data structure that keeps data sorted and allows searches, insertions, and deletions in logarithmic amortized time (log N).

Another type of data source may include a columnar database 115, similar to the relational database 110, which stores data in columns 118 rather than row-oriented structures. The columnar database 115 may provide efficient retrieval of data of having a small number of columns 118 across a large number of rows. Many analysis queries that require aggregations to be performed on selected columns 118 and columnar databases may be useful such use cases, due to potential storage and retrieval efficiency. Column-wise storage requires fewer disk reads to traverse specific columns 118. AMAZON REDSHIFT may provide an example of a columnar database 115 and APACHE PARQUET may provide an example of a columnar file format.

Another type of data source may include a key-value database 120 (also referred to as “key-value stores”). A key-value store 120 is a data storage paradigm designed for storing, retrieving, and managing associative arrays 123. An associate array 123 is a data structure more commonly known as a dictionary or hash. A key-value store 120 (e.g., RIAK, REDIS, MEMCACHE) may allow for fast retrieval of data based on a key. A key-value store 120 may be an implementation of a map data structure on disk or in memory. A key-value store 120 may follow consistency models which are based on serializability or eventual consistency. Accesses to the key-value store 120 are based on a key having almost 0(1) time complexity.

Another type of data source may include a web service 125. A web service 125 is a common integration touchpoint to proprietary data systems within or outside an enterprise environment 100. Access to most social media data are also through Representational State Transfer (REST) Application Program Interface (API). External cloud based applications 160 (e.g., Salesforce.com, Google Analytics) also can be accessed via REST APIs. The web service 125 may allow real-time request-response access to data, which may be stored in any kind of repository by the service provider.

Another type of data source is a file system stored in the shared storage in the enterprise environment. Among file systems, there are structured file data such as CSV and Excel, and structured data such as proposals and design documents. The storage for these files can be generic shared folders or specific document management systems.

Another type of data source could also be a live streaming data source 130 providing live data generated or received in real-time. Live data can be consumed from real-time streams from a socket (such as Kinesis or Kafka). Stream processing may serve a dual purpose in a Lambda Architecture—batch processing and real-time interactive processing. The latter may have sub-second latency requirements. Certain scenarios may also have re-processing requirements, if a stream event is missed.

Another data source could include a “big data” source 103. A big data source may store data in large amounts (e.g., on the order of multiple Terabytes (TBs) or larger) in clustered shared environments like Hadoop or Spark. Typically, big data may provide a SQL-like language to query them. A real-time (e.g., SPARKSQL, Impala) or asynchronous model (e.g., HIVE) may be followed.

Another data source could include data marts 140. A data mart can be an analytical cube in the form of Online Analytical Processing (OLAP) or Analysis Services (e.g., SQL Server Analysis Services (SSAS)). In some example implementations, an analytical query (e.g., SQL based) is issued to query data mart 140 sources. These analytical queries may be precomputed-aggregated and cleaned data, which can be fetched and used for various reporting needs.

Another data source could include access to a business objects layer 145. In an enterprise environment 100, business objects (e.g., SAP, Informatica) may be a suite of front-end applications that allow business users to view, sort and analyze business intelligence data. These front-end application layers can be directly queried using an API of the specific applications.

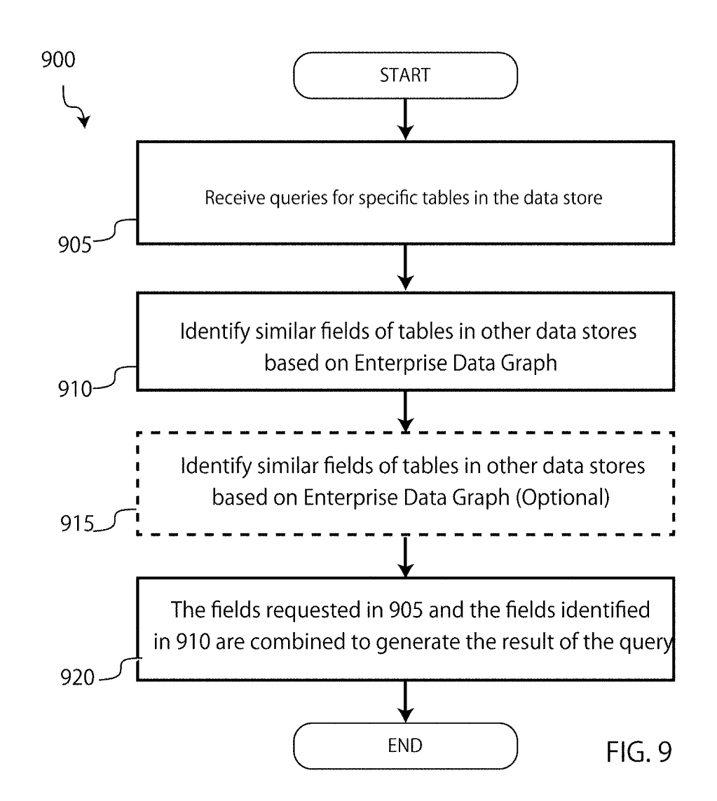

One or more of the data sources 105-145 may be communicatively connected to one another via, for example, a network 150 (e.g., by wireline and/or wireless connections). Additionally, a data management and analysis device 155 may be connected to the network 150. The data management and analysis device 155 may include, but is not limited to, a computer (e.g., a laptop or desktop), mobile devices (e.g., smartphone or tablet), a wearable device (e.g., a smart watch), and a server computer. The data management and analysis device 155 may have a computing environment 900 as shown below in FIG. 9.

In order to deal with the above problems, the data management and analysis device 155 can execute a process for data analysis described below. Although the embodiment primarily uses a relational database data source as an example, it is also applicable to other types of data sources.

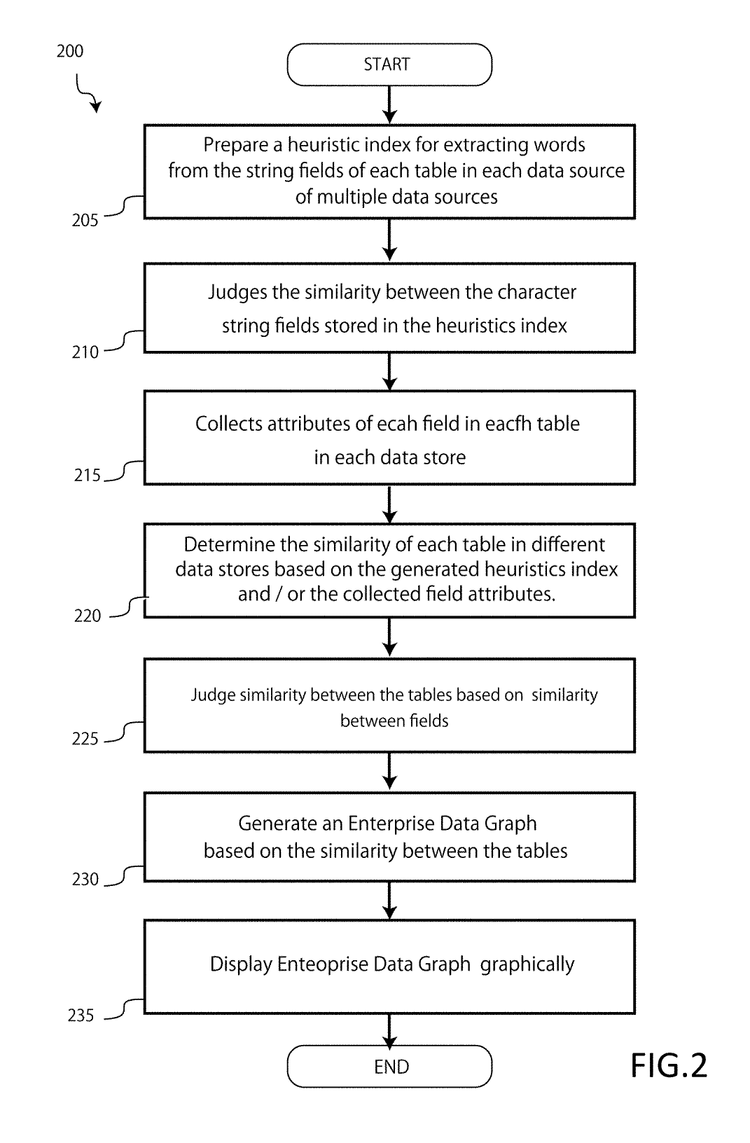

FIG. 2 shows an example of a process 200 executed by the data management and analysis device 155 to perform field similarity judgment between different data sources to generate enterprise data graph. Here, enterprise data graph is a graph representing a relationship between a plurality of data sources, a relationship between a plurality of data models in one or more data sources, or a relationship between entities stored in one or more data sources. The following examples describe enterprise data graphs representing relationships between entities, but similar ideas apply to relationships between data sources and data models. It is to be noted that an entity refers to a thing in the physical world represented by a database (data source) and corresponds to a table or a view (virtual table) in a relational database (in the following description, an entity and a table are synonymous, and the table shall include the view). In addition, a field refers to a column in a table.

(205) Prepare a heuristic index for extracting words from the string fields of each table in each data source of multiple data sources. Here, the heuristic index is an index for meaningful words in the text included in the string fields of the tables in the data sources, indicating which word of which table of which data source the word is and how often it is used. It can be implemented by the inverted index function provided by search engines such as Lucene.

(210) Next, the similarity determination algorithm judges the similarity between the character string fields stored in the heuristics index. Two of the specific examples of the algorithm will be described below.

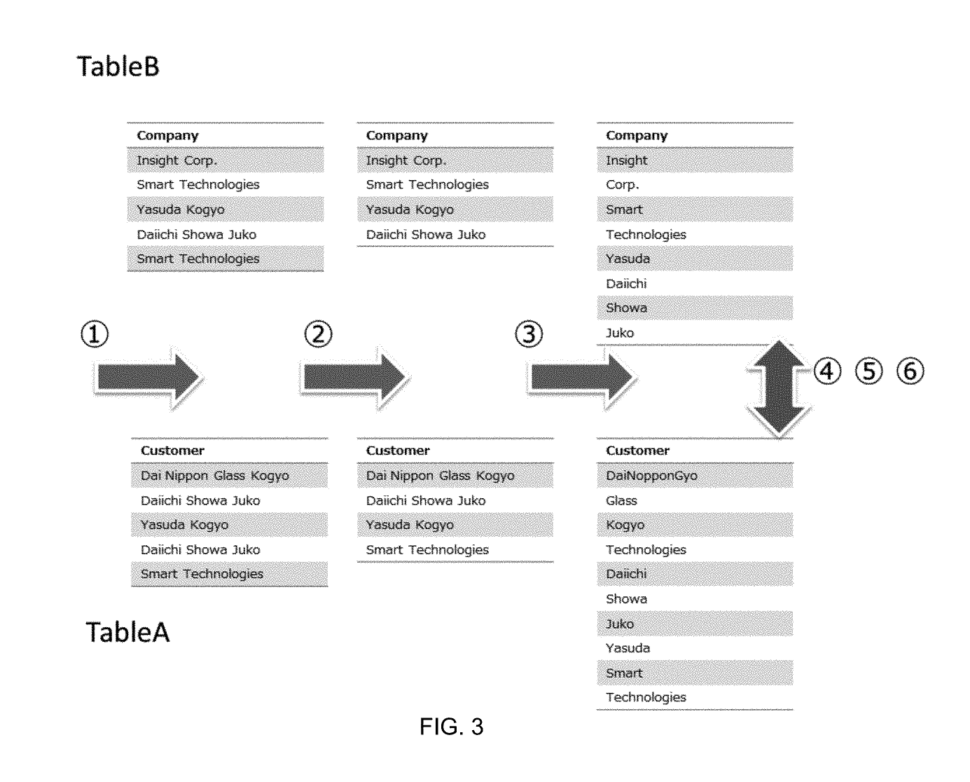

FIG. 3 shows the first embodiment of the similarity determination algorithm. In this example, the relevance is determined by the similarity of the character strings included in the field. Its characteristic is in considering partial matches and fluctuation due to tokenization, and so on, instead of perfect matches. For example, even if there are differences in representation for the same term by the data sources (e.g. “exterior device” and “device for exterior use”, “KK Patent” and “(KK) Patent”, similarity can be found. The first embodiment of the algorithms consists of the following steps. (1) Identify the character string field of each table, and acquire all the values in each field. (2) Apply the DISTINCT operation to the acquired value set and remove the duplication (focusing on “type” instead of “number of instances”). (3) Feed the de-duplicate value set to a search engine (e.g. Apache Lucene/Solr) that is capable of morphological analysis. Apply token decomposition by morphological analyzer or sequence division by n-gram process to character string. Division of the character strings can be adjusted by changing the schema in the search engine according to the users' needs. In the index structure of the search engine, an index storing “Bag of Words” is formed. Here, one character string corresponds to one document. (4) Calculate the cosine similarity between fields. (5) As the cosine similarity is a real value between 0 and 1 and there is a nonlinear relationship between the calculated value and the human-sensed similarity, apply a logistic function. It is preferable to increase the variation sensitivity near 0.5 and relax the sensitivity near 0.0 and near 1.0. The parameters of the logistic function are preferably changeable in the configuration file. (6) It is preferable to set an attribute such as high/medium/low/none or the like on the calculated similarity value between the fields based on predetermined threshold values.

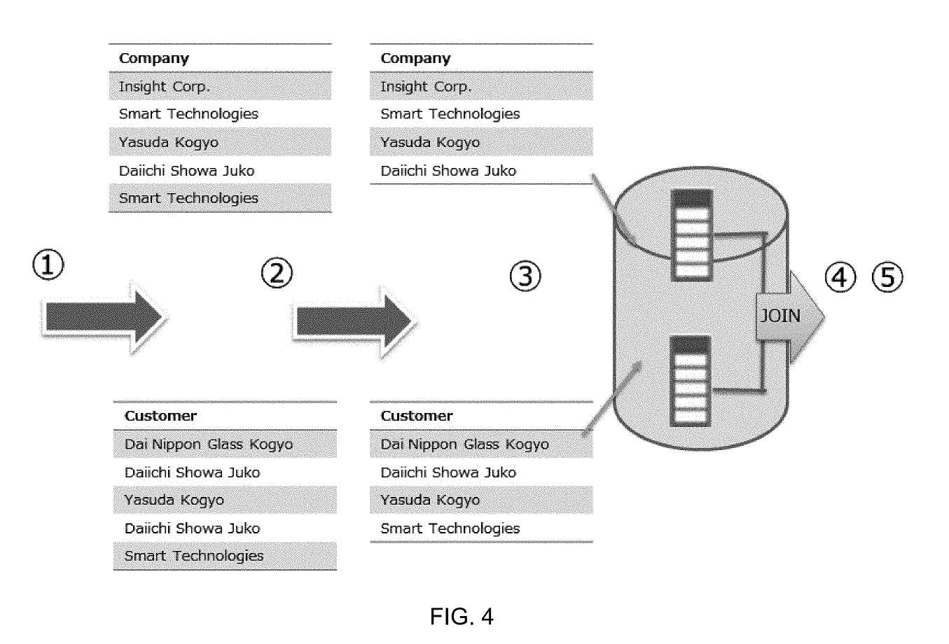

FIG. 4 shows the second embodiment of the similarity determination algorithm. In this example, the relevance is judged by the degree that the character string is included in the field. This method does not consider ambiguous fluctuation but judges with only perfect matches. It consists of the following steps. (1) Identify the character string type field from each data model and acquire all the values in each field. (2) Apply the DISTINCT operation to the acquired value set and remove the duplication (pay attention to “type” instead of “number of cases”). (3) The deduplicated value set is held in a temporary table of 1 column×n rows. An in-memory DBMS may be used for the temporary table. (4) In the temporary table group of 1 row×n rows generated in the above step 3, JOIN operation (natural join) is performed. The number of rows in this result set is compared with the number of records in the original two tables. (5) As a comparison method, three methods of Dice coefficient, Simpson coefficient, Jaccard coefficient are applied and the similarity of each is obtained. Three values are weighted and synthesized, and a real value (similarity) with a range of 0 to 1 is calculated. (6) It is preferable to discard all the temporary table groups of 1 column×n rows after the similarity is calculated by combination of all the tables. (7) It is preferable to set an attribute such as high/medium/low/none or the like based on the calculated similarity value between the fields based on predetermined threshold values.

(215) Further, attributes (e.g., density (cardinality), number of distinct values (NDV), range of histogram, number of null values, number of non-null values) of each field (not limited to character string fields) may be collected and stored.

(220) Determine the similarity of each table in different data stores based on the generated heuristics index and/or the collected field attributes. Weighted average of the similarity based on the heuristics index and the similarity based on the collected field attributes can be used. Tables may be determined to be similar when the weighted average is larger than a predetermined threshold. When the similarity determined by the heuristic index exceeds a predetermined threshold value, it may be determined that the tables are similar regardless of the similarity determined by the field attributes. When the similarity determined by the field attribute exceeds the predetermined threshold value, it may be determined that the tables are similar regardless of the similarity determined by the heuristic index. When the similarity determined by the heuristic index is equal to or less than the predetermined threshold value, it may be determined that the tables are not similar regardless of the similarity determined by the field attribute. When the degree of similarity determined by the field attribute is equal to or less than the predetermined threshold value, it may be determined that the tables are not similar irrespective of the similarity determined by the heuristic index. It is preferable that such a determination method and a predetermined threshold value can be set by the user as a parameter or described as a script.

(225) The similarity between the tables is judged based on the similarity between the judged fields. It is preferable to treat the tables containing many fields determined to be similar as having strong similarity.

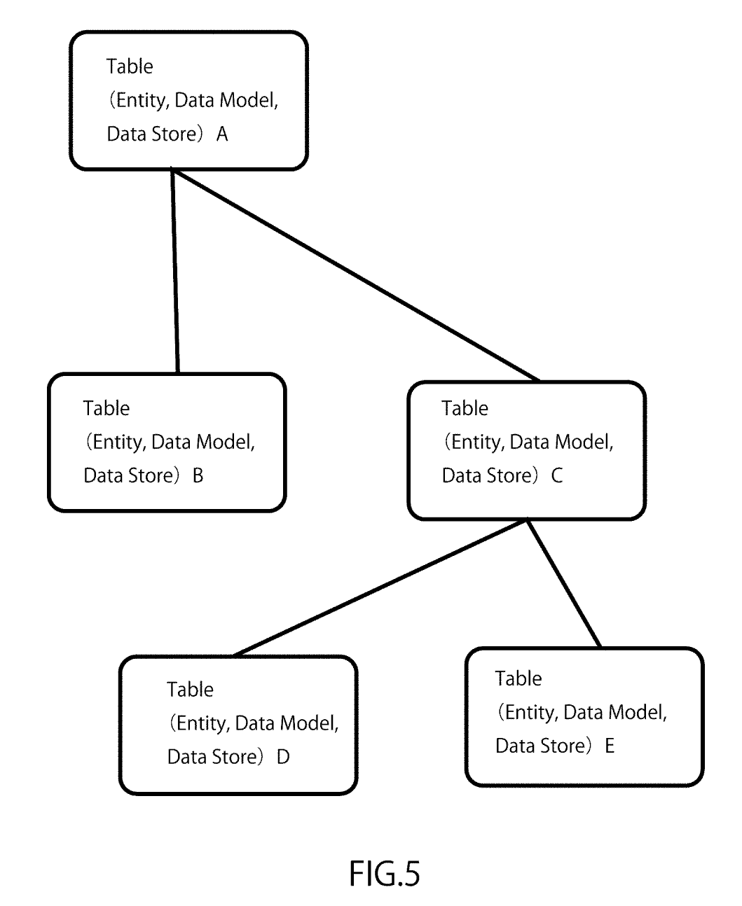

(230) Generate an enterprise data graph based on the similarity between the tables under determination. FIG. 5 shows a schematic representation of an example of enterprise data graph according to the present invention. A node of enterprise data graph is a table (entity) that belongs to different data sources, but contains fields determined to be similar, and edges represent similarities between the tables. Similarity between the tables may be set according to the number of similar fields and similarity thereof. In this example, each node is a table, but similar concepts between data sources and data models may be expressed in the same way.

(235) The generated enterprise data graph is preferably displayed graphically on the screen to enhance understanding of the relationship between the user's data and to support queries across the data source.

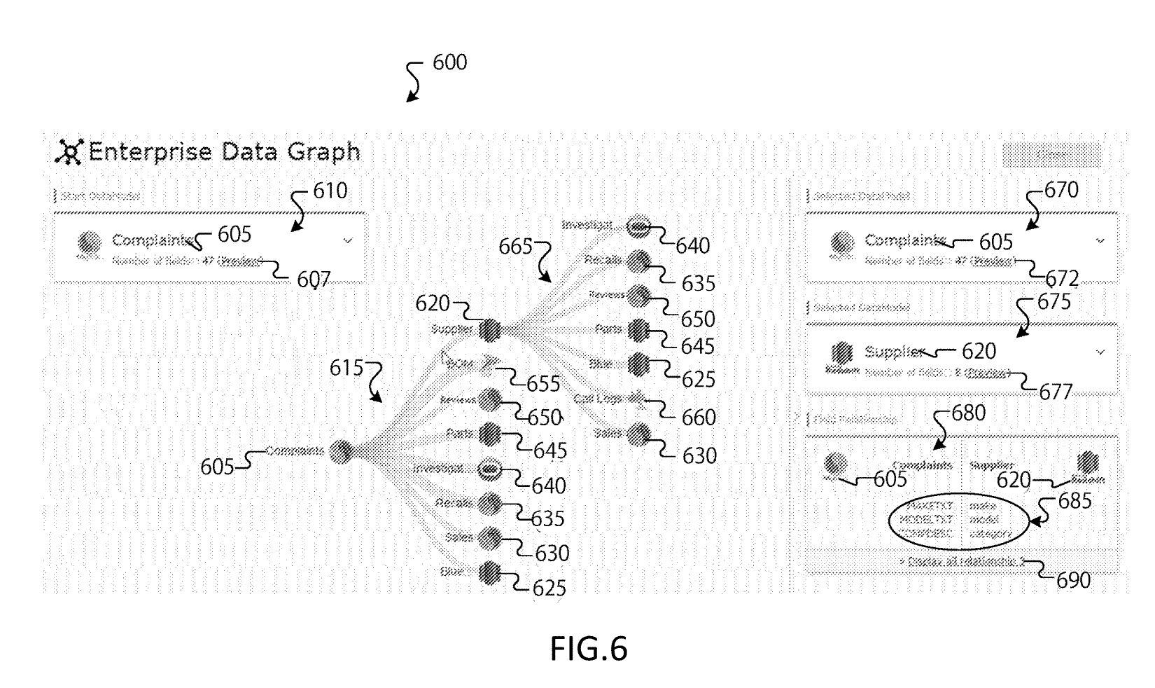

FIG. 6 illustrates an enterprise data graph 600 according to an example implementation of the present application. As illustrated, the enterprise data graph 600 may include an area 610, which identifies a starting data store 605 (e.g., “Complaints”) used as a starting point for mapping the relationships between data repositories. The area 610 may also include information (e.g., number of fields) about the starting data store 605 and a link 607 for reviewing the fields, and/or entities of the starting data store 605. This starting data repository 605 may be selected by a user or may be automatically selected based on a query received from the user.

The enterprise data graph 600 may also include an area 615 illustrating the mapped relationships between the starting data repository 605 and a plurality of other data repositories 620-655, which have been determined to have related, matching, or corresponding fields or data entities to the starting data repository 605, based on heuristic and/or statistical analysis. As illustrated, the starting data store 605 (“Complaints”) has been determined to be related to eight other data stores (620-655). These other data stores include data store 620 (“Supplier”), data store 625 (“Blue” value), data store 630 (“Sales”), and data store 635 (“Recalls”). The other data repositories also include data store 640 (“Investigations”), data repository 645 (“Parts”), data store 650 (“Reviews”), and data store 855 (“BOM”). These multiple data stores might have different design and their data might be inconsistent, but, using the algorithm of the present invention, the relationship among tables (entities) and data stores (data repositories) can be represented graphically, and assist users' analytical tasks.

In some example implementations, the enterprise data graph 600 may also include an area 665 illustrating data stores 625-650 and data store 669 determined to have related, matching, or corresponding fields or data entities to a data repository 620 selected by a user.

Some of these data repositories may have been determined to also include related, matching, or corresponding fields or data entities to starting data store 605 in area 615. For example, data store 625 (“Blue” value), data store 630 (“Sales”), data store 635 (“Recalls”), data store 640 (“Investigations”), data store 645 (“Parts”), and data store 650 (“Reviews”) are all illustrated in both area 615 and area 665.

However, some of the data stores illustrated in area 665 may not have been illustrated in area 615 and thus do not include related, matching, or corresponding fields or data entities to starting data store 605. Further, some of the data stores illustrated in area 615 may not be illustrated in area 665 and thus do not include related, matching, or corresponding fields or data entities to user selected data store 620. For example, data repository 660 (“Call logs”) is only illustrated in area 665 and thus, does not include related, matching, or corresponding fields or data entities to starting data store 605. Similarly, data store 655 (“BOM”) is only illustrated in area 615 and thus, does not include related, matching, or corresponding fields or data entities to user selected data store 820.

The enterprise data graph 600 may also include an informational area 670 providing information (e.g., number of fields) about the starting data store 605 and a link 672 for reviewing the fields, and/or entities of the starting data store 605.

Further, the enterprise data graph 600 may also include an informational area 675 providing information (e.g., number of fields) about the user selected data store 620 and a link 677 for reviewing the fields, and/or entities the user selected data store 620.

Further, the enterprise data graph 600 may also include an informational area 680 providing information about the identified relationships between the starting data store 605 and the user selected data store 820. The provided information may include a listing 685 of the fields in the starting data repository 605 determined to match, correlate with, or be related to fields in the user selected data repository 620. The informational area 680 may also include a link 690 for reviewing the fields in the starting data store 605 determined to match, correlate with, or be related to fields in the user selected data store 620.

Various examples of various queries (data inquiry requests) using the enterprise data graph and/or heuristics indexes generated by the process of FIG. 2 will be described below.

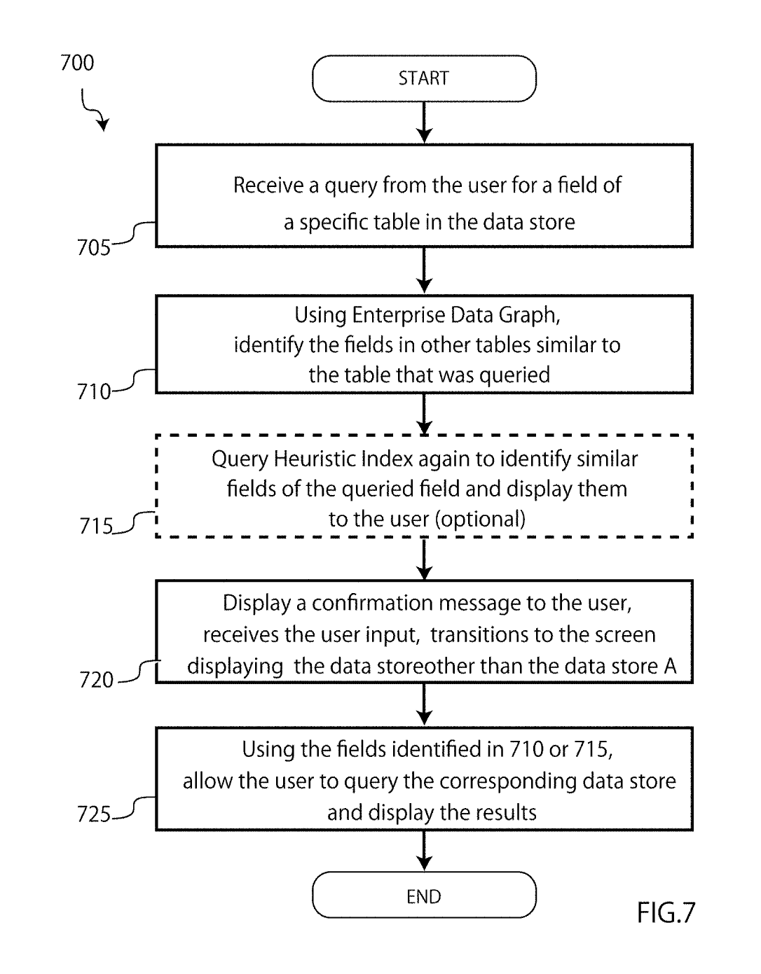

FIG. 7 shows a process 700 of the first embodiment (referred to herein as Data Chain) of a query using enterprise data graph, which may be performed by an embodiment of the data management and analysis device 155 of the present application.

(705) Receive a query from the user for a field of a specific table in the data store.

(710) Using enterprise data graph, identify the fields in other tables similar to the table that was queried.

(715) Optionally, the heuristic index may be queried again to identify similar fields of the queried field and display them to the user.

(720) Upon identifying similar fields and tables containing those fields, display a confirmation message to the user, receive the user input, transition the screen display to the screen displaying the data store other than the data store A. At this time, a plurality of tables may be displayed, letting the user select one.

(725) Use the fields identified in 710 or 715 to allow the user to query the corresponding data store and display the results.

This embodiment is useful, for example, in the case of analyzing shipment details and production result data stored in different data stores by using the product serial number inquired at the call center. This scenario is advantageous in that it can reach the relevant data store or table only even if the words do not match perfectly, unlike a table-to-table relationship of ordinary RDBMS.

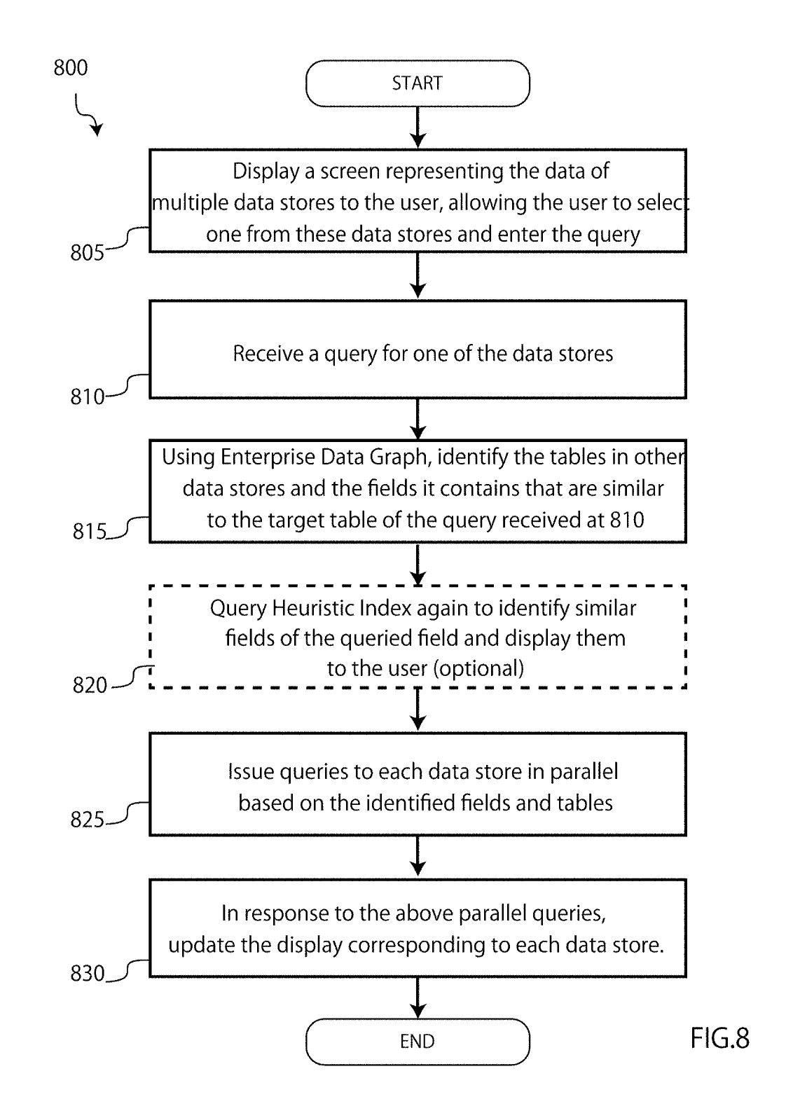

FIG. 8 shows the process (800) for the second embodiment of a query (called a federated query) using enterprise data graph that can be executed by a data management analysis device (155) in the present application.

(805) Displays a screen representing the data of multiple data stores to the user, allowing the user to select one from these data stores and enter the query.

(810) Receive a query for one of the data stores.

(815) Using enterprise data graph, identify the tables in other data stores and the fields it contains that are similar to the target table of the query received at 810.

(820) Optionally, the heuristic index may be queried again, the fields associated with the user's query may be identified and displayed to the user.

(825) Issue queries to each data store in parallel based on the identified fields and tables above.

(830) In response to the above parallel queries, update the display corresponding to each data store. For example, if a user sends a query to narrow down the query period to a data store, equivalent queries are issued to other data stores, each screen display may be changed, increasing data analysis efficiency for the users.

FIG. 9 shows the third embodiment of a query using enterprise data graph (referred as real time data fusion, virtual integration, or composite data model) process (900).

(905) Receive queries for specific tables in the data store.

(910) Identify similar fields of tables in other data stores based on enterprise data graph.

(915) Optionally, display the choices of fields identified as similar, allowing the user to select.

(920) The fields requested in 905 and the fields identified in 910 are combined to generate the result of the query. This embodiment allows two or more physically distinct data stores to be treated like a single data store. For example, when sales data for each region is stored in multiple databases or tables, analysis can be performed as if it were a single table without physical integration, improving users' convenience.

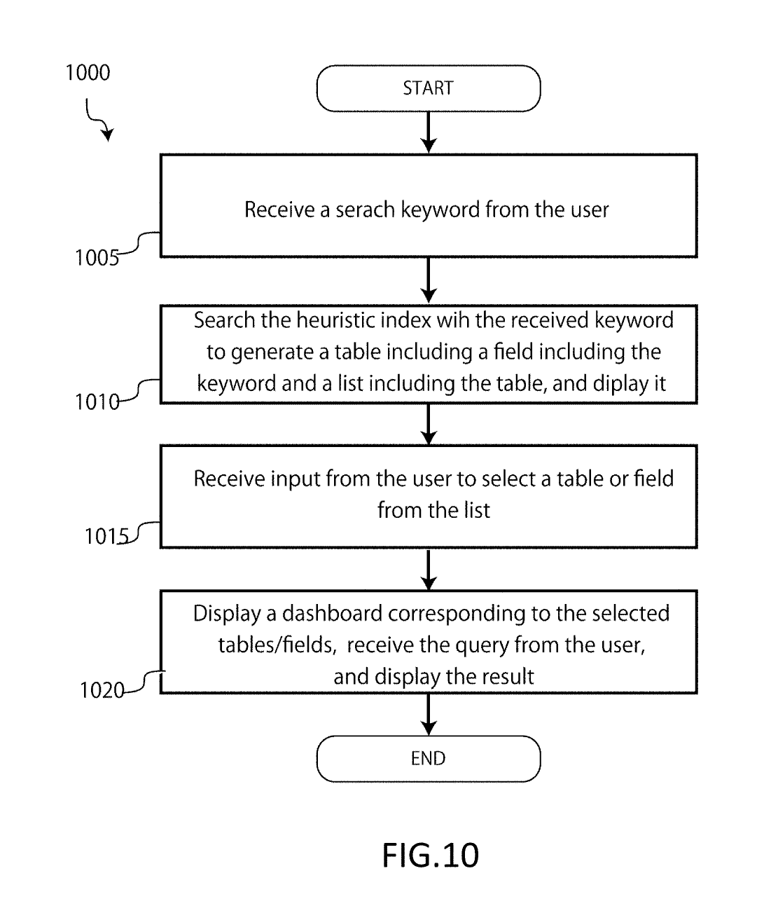

FIG. 10 shows a process (1000) of the fourth embodiment (referred to as Mμgen search) of a query using a heuristics index, which can be executed by a data management and analysis device (155) according to an embodiment of the present invention.

(1005) Receive a character string (keyword) to be searched from the user. At this time, a heuristic index may be searched for and auto complete (suggestion) may be performed.

(1010) Search the heuristic index based on the received keyword to generate a table including a field including the keyword and a list including the table, and display the table to the user.

(1015) Receive input from the user to select a table or field from the list.

(1020) Display the screen (dashboard) corresponding to the selected tables or fields, receive the inquiry request from the user, and display the result. This embodiment exhaustively searches for a wide variety of data stores and discovers data stores that may be associated with specific keywords. For example, by entering the model name of a car as a keyword and cross-searching for recall related information, supply chain related information, and production system related information, it is possible to quickly take countermeasures against complaints for that vehicle type.

In addition to the embodiments described above, enterprise data graphs and heuristics indexes can be used to facilitate various queries across multiple data stores. For example, all (or part of) values contained in a specific field of the current search result can be used to traverse across other data stores. In the method according to the present invention, since relations between tables are extracted as a heuristics index and an enterprise data graph, it is possible to reduce the number of data stores, making efficient data queries and analysis possible even in a large-scale system including a large number of data stores.

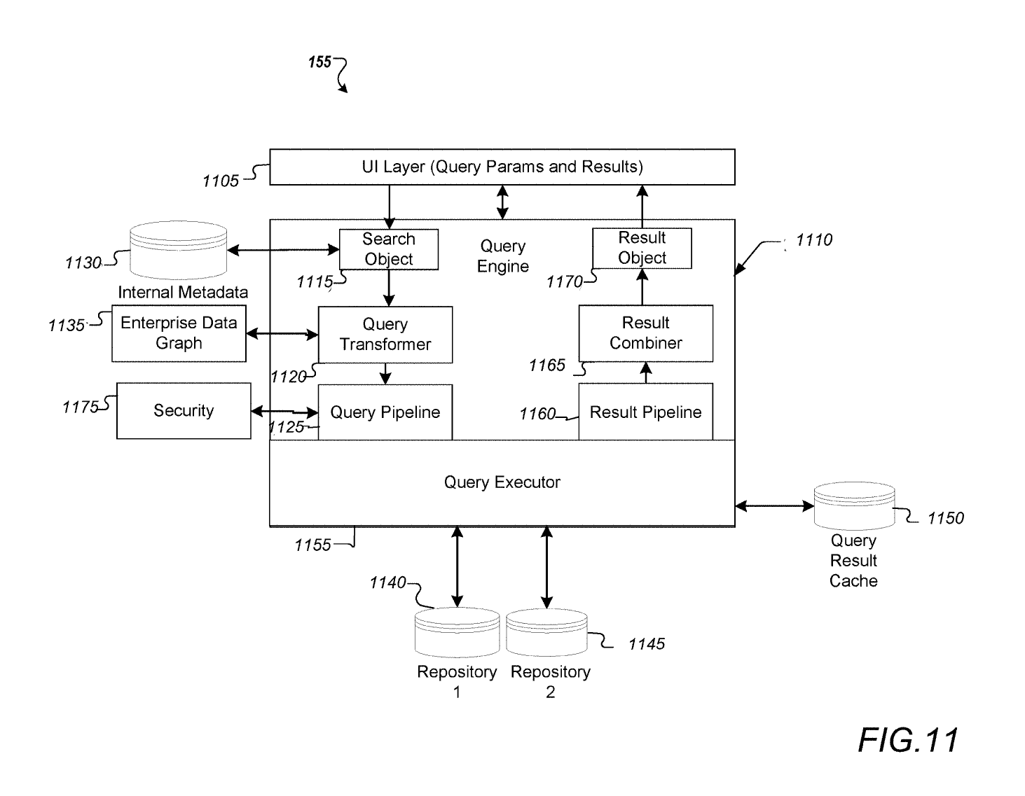

FIG. 11 illustrates a functional schematic of an example embodiment of the data management and analysis device 155 illustrating the execution of queries during one or more of the process discussed above with respect to FIGS. 7-10. As illustrated in FIG. 11, the data management and analysis device 155 may include a user interface (UI) layer 1105 that receives the query parameters (Params) from the user and presents the query results to the user. The UI layer 1105 receives the query and provides the query to a query engine 1110. The query engine 1110 includes a query transformer (QT) 1120, a query pipeline 1125, a query executor 1155, a result pipeline 1160, and a result combiner 1165.

Within the query engine 1110, query transformer (QT) 1120 captures queries from the UI layer 1105 through various form elements and translates to one or more generic search objects 1115 which can be passed to the QT 1120. Search object 1115 has all metadata (data model, field, data repository, filters) associated to a query looked up from internal metadata 1130. A role of the QT 1120 may be to lookup the enterprise data graph 1135 and identify corresponding fields or matched fields and entities to query in case of a federated search scenario. QT 1120 transforms the search object 1115 based on the enterprise data graph 1135. Search object 1115 is then fed into a query pipeline 1125, which may decide a sequence of queries to be executed and adds other transformations like security 1175 to the search object 1115. Prior to executing the query, this query executor 1155 component may also check if the result for the query exists in a query result cache 1150. If the query is a single data source query, the query can then be executed by the query executor 1155 directly.

In the event of a composite (e.g., a query to multiple data repositories 1140, 1145 or a “multi-source query”), the entire query execution flow may be logged along with corresponding statistics in the internal metadata storage 1130. For example, the following statistics may be logged:
Query transformation time
Execution time of physical query
Network transfer time for every network transfer
The query template/format for which this workflow is executed

The query executor 1155 may take the search object 1115 and translate the search object 1115 into a query which can be executed directly using the APIs or language of the native data engine. In some example implementations, pushdowns may be used as much as possible for maximum efficiency of query execution. query executor 1155 may then return a generic result structure to the result pipeline 1160.

The query executor 1155 may return multiple query results the result pipeline 1160, which coordinates the sequence of results to be returned. A result transformation based on custom result logic may also occur in this layer in some example implementations.

If the composite query invokes multiple queries, each to a different physical data source, the result combiner 1165 may be invoked to join or combine intermediate results at every join point in the query. For example, the result combiner 1165 may accept the intermediate results and decide the best combining strategy, and then return the combined result of both intermediate data-sets. In case of “big data” scale joins between the data sets, the result combiner 1165 may use a distributed join strategy by performing the computation using a clustered in-memory engine (e.g., APACHE SPARK). However, such a query may not be executed in real-time and may be performed asynchronously, since processing in a clustered environment includes overheads beyond network overhead.

If the cardinality (e.g., scale) of the intermediate data-sets is of a smaller magnitude, then an in-memory SQL engine can be used to perform the join. In some example implementations, bulk inserts to a RAM disk table and subsequent SQL may be fast enough for real-time execution.

In some example implementations, the join may be performed across two data sources (e.g., data repository 1 and data repository 2) at the result combiner 1165 by fetching each of the intermediate results and then applying an appropriate join algorithm to produce a result object 1170 that may be returned to the UI layer 1105.

A number of joining strategies may be used to merge the results. In some example implementations, an in-memory SQL engine may be used. For example, the intermediate data-sets may be written to a POSTGRESQL or MYSQL table on RAM Disk (which may reside on a different server on the same network). Subsequently, the SQL join query (which may be used with computed expressions) is run on the database to derive the final result set. The final result set may be sent back to the result combiner 1165. Similarly, other in-memory SQL engines (e.g., MemSQL may also be used). The infrastructure running the in-memory server may have a high memory capacity. Similarly, columnar databases may be used. When queries are complex and target data sources are not quite efficient, columnar databases can provide the users excellent query performance.

In other example implementations, it may be beneficial to perform as much processing as possible on the native data source. Pushing down searches, comparisons, local joins, sorting, aggregation and grouping to the underlying data source may allow the capabilities of that data source to be exploited and limits the amount of intermediate data transported over the network and processed by the in-memory engine.

In other example implementations, query caching of data may be used. For example, a cache cluster (e.g., REDIS or MEMCACHED) may be configured to store results on a per query basis. Before executing a query on any data store, the cache may be checked for availability of results. If the data is not available, then only the data source may be hit. A performance gain may be achieved for frequently run queries against high latency sources. Performance gain may also be appreciable for engines which do not have their own caching capability (e.g., IMPALA) and composite queries (e.g., queries in which the query is split into multiple physical queries and results merged by an in-memory SQL engine).

In other example implementations, concurrent processing may be performed. For example, if a query spans many data sources, then parallel processing may reduce query execution time. Further, in some example implementations, during query execution plan determination, mutually exclusive queries can be identified to execute in parallel threads.

In other example implementations, distributed processing may be performed. For example, distributed processing capabilities of native data sources may inherently be utilized while querying with certain engines (e.g., HIVE, IMPALA) on the Hadoop platform or Spark platforms. However, in some example implementations, distributed join for large intermediate sets on a clustered engine like Spark or Hadoop may require ecosystem tools.

Further, in some example implementations, non-real time optimal query plan generation may be used. For example, the query engine 1110 may log the execution time of every stage in a query execution workflow. This log may include query processing on a data store for a particular data model as well as network transfers and data merging. This log can serve as valuable data to optimize a query plan further for subsequent query workflow executions. To avoid overhead of exploration of the optimal execution graph, this optimization process may be carried out in a background process which determines the optimal execution plan and caches it in the internal metadata storage 1130 for re-use.

(Example Computing Environment)

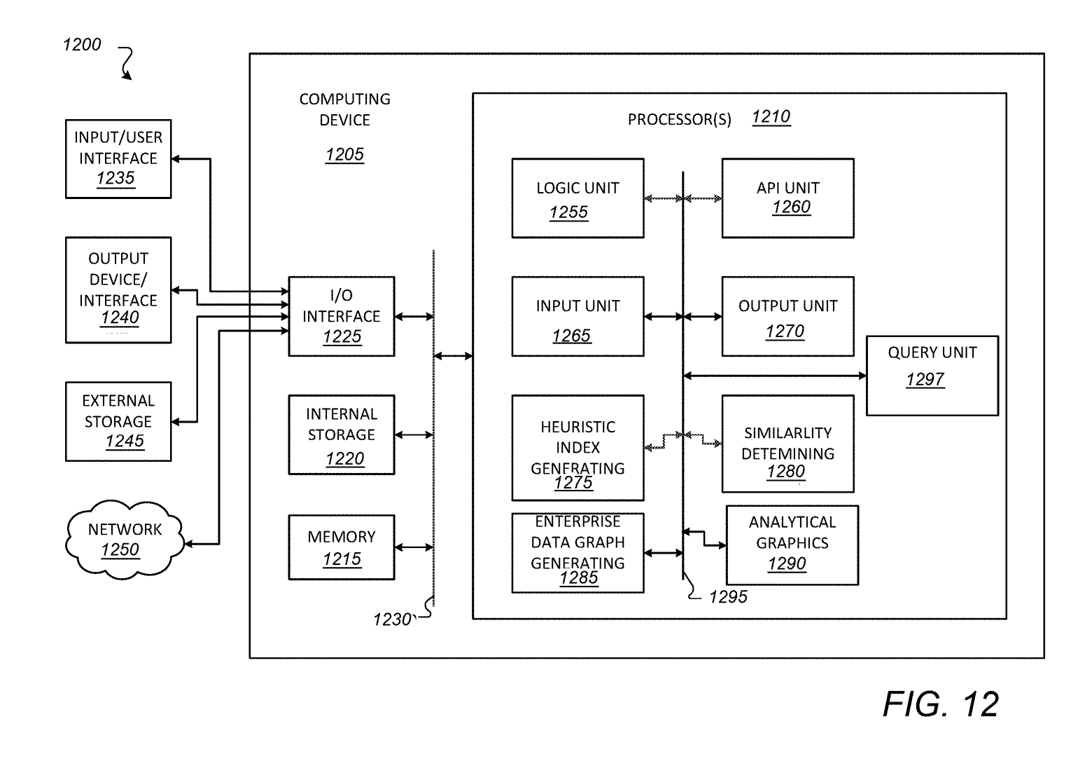

FIG. 12 illustrates an example computing environment 1200 with an example computing device 1205 suitable for use in some example implementations. Computing device 1205 in computing environment 1200 can include one or more processing units, cores, or processors 1210, memory 1215 (e.g., RAM, ROM, and/or the like), internal storage 920 (e.g., magnetic, optical, solid state storage, and/or organic), and/or 110 interface 1225, any of which can be coupled on a communication mechanism or bus 1230 for communicating information or embedded in the computing device 1205.

Computing device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, which can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computing device 1205. In other example implementations, other computing devices may function as or provide the functions of input/user interface 1235 and output device/interface 1240 for a computing device 1205.

Examples of computing device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 1205 can be communicatively coupled (e.g., via I/O interface 1225) to external storage 1245 and network 1250 for communicating with any number of networked components, devices, and systems, including one or more computing devices of the same or different configuration. Computing device 1205 or any connected computing device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computing device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1210 can execute under any operating system (OS) (not shown), in a native or virtual environment. One or more applications can be deployed that include logic unit 955, application programming interface (API) unit 1260, input unit 1265, output unit 1270, heuristic index generating unit 1275, similarity determining unit 1280, enterprise data graph generating unit 1285, analytical graphics unit 1290 and inter-unit communication mechanism 1295 for the different units to communicate with each other, with the OS, and with other applications (not shown). For example, heuristic index generating unit 1275, similarity determining unit 1280, enterprise data graph generating unit 1285, and analytical graphics unit 1290 may implement one or more processes shown in FIGS. 2-10. The described units and elements can be varied in design, function, configuration, or implementation and are not limited to the descriptions provided.

In some example implementations, when API unit 1260 receives information or an execution instruction, it may be communicated to one or more other units (e.g., heuristic index generating unit 1275, similarity determining unit 1280, enterprise data graph generating unit 1285, analytical graphics unit 1290, and query unit 1297). For example, when the heuristic index is generated via the heuristic index generating unit 1275, the heuristic index may be provided to the similarity-determining unit 1280 to determine similarities between different entities. Additionally, the similarity determining unit 1280 may provide the similarities to the enterprise data graph generating unit 1285 for use in generating the enterprise data graph. Further, the enterprise data graph generating unit 1285 may be provided to the analytical graphics unit 1290 to generate representative data analytical graphics that are displayed using the output unit 1270.

In some instances, the logic unit 1255 may be configured to control the information flow among the units and direct the services provided by API unit 1260, input unit 1265, output unit 1270, heuristic index generating unit 1275, similarity determining unit 1280, enterprise data graph generating unit 1285, and analytical graphics unit 1290 in some example implementations described above. For example, the flow of one or more processes or implementations may be controlled by logic unit 1255 alone or in conjunction with API unit 1260. The query unit 1297 coordinates with the API unit 1260, logic unit 1255, and similarity determining unit 1280 to form and execute queries in respective data repositories.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

1. A computer-executable method for analyzing data in multiple data stores comprising:
removing duplicates from a set of strings in multiple fields in tables in the multiple data stores;
storing the set of strings into an inverted index;
evaluating similarity among the multiple fields based on similarity of the strings stored in the inverted index; and
generating a graph, each node of the graph representing a table containing a similar field, and an edge of the graph representing similarity between the tables.

2. The method according to claim 1, wherein,
the evaluating similarity step further comprising:
dividing the set of strings in the multiple fields by applying morphological analysis;
calculating a cosine similarity between the strings; and
applying a logistics function to the cosine similarity.

3. The method according to claim 2, wherein,
the evaluating similarity step further comprising:
storing a set of strings in the multiple fields into a-temporary tables;
applying a natural join to the temporary tables; and
calculating a similarity between the temporary tables.

4. The method according to claim 1, further comprising:
evaluating similarity between the multiple fields in tables in the multiple data stores, based on attributes of the fields;
wherein the attributes include cardinality, non-distinctive values, a range of a histogram, a number of null values, and a number of non-null values.

5. The method according to claim 1, further comprising:
receiving a query to a first field in a first table in a first data store;
identifying, using the graph, a second field that is similar to the first field; and
displaying information about the second field, a second table containing the second field or a second data store containing the second table.

6. The method according to claim 1, further comprising:
displaying information on a first data store;
receiving a query to a first field in a first table in a first data store;
identifying, using the graph, a second field that is similar to the first field;
displaying information on a second data store containing the second field; and
updating display of the information of the first data store and the information of the second data store simultaneously.

7. The method according to claim 1, further comprising:
receiving a query to a first field in a first table in a first data store;
identifying, using the graph, a second field that is similar to the first field; and
displaying the result of the query to the first data store and a second data store containing a second table containing the second field on a same screen.

8. The method according to claim 1, further comprising:
receiving a keyword from a user;
searching tables containing a field containing the keyword from the inverted index; and
displaying the table or the field.

9. A non-transitory computer-readable storage medium comprising a recorded computer program for analyzing data in multiple data stores comprising computer-executable instructions for:
removing duplicates from a set of strings in multiple fields in tables in the multiple data stores;
storing the set of strings into an inverted index;
evaluating similarity among the multiple fields based on similarity of the strings stored in the inverted index; and,
generating a graph, each node of the graph representing a table containing a similar field, and an edge of the graph representing similarity between the tables.

10. The non-transitory computer-readable storage medium comprising the recorded computer program according to claim 9, wherein:
the instructions for evaluating similarity further comprising computer-executable instructions for:
dividing the set of strings in the multiple fields by applying morphological analysis;
calculating a consine similarity between the strings; and
applying a logistics function to the cosine similarity.

11. The non-transitory computer-readable storage medium comprising the recorded computer program according to claim 9, wherein:
the instructions for evaluating similarity further comprising computer-executable instructions for:
storing a set of strings in the multiple fields into temporary tables;
applying a natural join to the temporary tables; and
calculating a similarity between the temporary tables.

12. The non-transitory computer-readable storage medium comprising the recorded computer program according to claim 9 further comprising computer-executable instructions for:
evaluating similarity between the multiple fields in tables in the multiple data stores, based on attributes of the fields;
wherein the attributes include cardinality, non-distinctive values, a range of a histogram, a number of null values, and a number of non-null values.

13. The non-transitory computer-readable storage medium comprising the recorded computer program according to claim 9 further comprising computer-executable instructions for:
receiving a query to a first field in a first table in a first data store;
identifying, using the graph, a second field that is similar to the first field; and
displaying information about the second field, a second table containing the second field or a second data store containing the second table.

14. The non-transitory computer-readable storage medium comprising the recorded computer program according to claim 9 further comprising computer-executable instructions for:
displaying information on a first data store;
receiving a query to a first field in a first table in a first data store;
identifying, using the graph, a second field that is similar to the first field;
displaying information on a second data store containing the second field; and
updating display of the information of the first data store and the information of the second data store simultaneously.

15. The non-transitory computer-readable storage medium comprising the recorded computer program according to claim 9 further comprising computer-executable instructions for:
receiving a query to a first field in a first table in a first data store;
identifying, using the graph, a second field that is similar to the first field; and
displaying the result of the query to the first data store and a second data store containing a second table containing the second field on a same screen.

16. The non-transitory computer-readable storage medium comprising the recorded computer program according to claim 9 further comprising computer-executable instructions for:
receiving a keyword from a user;
searching tables containing a field containing the keyword from the inverted index; and
displaying the table or the field.

17. A computer system for analyzing data in multiple data stores comprising:
a duplicate-remover that removes duplicates from a set of strings in multiple fields in tables in the multiple data stores;
a storer that stores the set of strings into an inverted index;
an evaluator that evaluates similarity among the multiple fields based on similarity of the strings stored in the inverted index; and,
a generator that generates a graph, each node of the graph representing a table containing a similar field, and an edge of the graph representing similarity between the tables.

18. The computer system according to claim 17 wherein:
the evaluator further comprising:
a divider that divides the set of strings in the multiple fields by applying morphological analysis;
a calculator that calculates a cosine similarity between the strings; and
an applier that applies a logistics function to the cosine similarity.

19. The computer system according to claim 18 wherein:
the evaluator further comprising:
a storer that stores a set of strings in the multiple fields into temporary tables;
an applier that applies a natural join to the temporary tables; and
a calculator that calculates a similarity between the temporary tables.

20. The computer system according to claim 17 further comprising:
an evaluator that evaluates similarity between the multiple fields in tables in the multiple data stores, based on attributes of the fields;
wherein the attributes include cardinality, non-distinctive values, a range of a histogram, a number of null values, and a number of non-null values.
